(19) United States
(12) Patent Application Publication
(10) Pub. No.: US 2015/0220880 A1
(43) Pub. Date: Aug. 6, 2015

(54) SUGGESTING A CANDIDATE ENROLLMENT ITEM FOR A CANDIDATE STUDENT

(71) Applicant: Apollo Education Group, Inc., Phoenix, AZ (US)

(72) Inventors: ANIL MAIPADY, San Jose, CA (US); SHRIDHAR NAVANAGERI, Sunnyvale, CA (US); NARENDER VATTIKONDA, San Jose, CA (US); RAGHAVENDRA REDDY MOORAM, Sunnyvale, CA (US); SUDHAKAR SUBASHCHANDRABOSE, San Jose, CA (US)

(21) Appl. No.: 14/174,158

(22) Filed: Feb. 6, 2014

(51) Int. Cl. G06Q 10/10; G06Q 50/20

(52) U.S. Cl. CPC G06Q 10/10; G06Q 50/2053

(57) ABSTRACT

Methods, stored instructions, and machines are provided herein for suggesting a candidate enrollment item for a candidate student. One or more computing devices, such as one or more recommendation servers, operate a recommendation service that suggests candidate enrollment items. The recommendation service collects, receives, or otherwise accesses information relevant to student interests or goals and information relevant to the quality and characteristics of enrollment items. This information is aggregated, analyzed, and used to suggest individual enrollment item(s) or an academic program of enrollment items that match individual student interest(s) or a set of student interests. The recommendation service may also monitor student actions that are taken based on or in light of the suggestion, and the recommendation service may adjust future suggestions based on these actions.

### TECHNICAL FIELD

The technical field relates to providing information about enrollment options.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Students at colleges, universities, and other schools or educational institutions often register for courses, programs, or other candidate enrollment items based on set requirements for their major, minor, or field of study. For non-required courses, students often select courses that look interesting based on the course description, or courses that otherwise fit well within their schedules. For example, a student may consult a course catalog that describes courses that cover different subjects, such as Digital Signal Processing or Logic and Reasoning.

Existing students and prospective students are referred to herein as “candidate students” that may enroll in a candidate enrollment item, for example, by registering to take a course during a semester or a program that may include multiple courses and may span a single semester, multiple semesters, or even multiple years. For example, a student may participate in a Computer Science and Engineering program or Political Science program, which may conclude in a degree, certificate, or specialization in Computer Science and Engineering or Political Science.

To help students enroll, electronic systems and devices may provide “enrollment interfaces” that allow students to select enrollment items and secure their selections. Enrollment interfaces may receive selections of enrollment items by candidate students, and the enrollment interfaces may prompt candidate students to secure their selections. For example, an enrollment interface may allow a student to secure his or her placement in the enrollment item, which may or may not have a limited capacity. Once the selection of an enrollment item has been secured, the student may be able to immediately begin participating in the enrollment item, may be able to participate in the enrollment item after a registration period has closed, or may be able to change enrollment items before or after the registration period has closed. If a student withdraws from or drops an enrollment item after the registration period has closed, the enrollment system may cause penalties to be assessed to the student or may record the withdrawal or drop an event on a student's academic record.

Candidate students may also work with counselors before making selections. Counselors advise students based on human intuition often during in-person meetings with candidate students. Enrollment advice may vary from counselor to counselor, and from time to time even for a particular counselor. The enrollment advice from the counselor could be based on nothing more than a feeling, and, if the counselor is also a professor, the advice may be biased towards or away from the counselor's areas of expertise. Ultimately, a student's enrollment decisions and academic future may be highly dependent on a brief in-person meeting based on a cursory discussion between the student and the counselor. Students deserve better advice, but constraints on counselor time, the counselor's personal and/or professional agenda, and the counselor's lack of familiarity with factual information continue to interfere with the quality of the advice.

### BRIEF DESCRIPTION OF THE DRAWINGS

In the drawings:

FIG. 1 illustrates an example system for suggesting enrollment items to candidate students.

FIG. 2 illustrates an example process for suggesting enrollment items to candidate students.

FIG. 3 illustrates an example enrollment interface that prompts a candidate student for interest input.

FIG. 4 illustrates an example enrollment interface that displays enrollment options and details about suggested enrollment items.

FIG. 5 illustrates an example computer system that may be specially configured to perform various techniques described herein.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Methods, stored instructions, and machines are provided herein for suggesting a candidate enrollment item to a candidate student. One or more computing devices, such as one or more recommendation servers, operate a recommendation service that suggests candidate enrollment items, such as courses, programs, or fields of study, for candidate students. The recommendation service may be a centralized service that collects, receives, or otherwise accesses information relevant to student interests or goals and information relevant to the quality and characteristics of enrollment items. This information is aggregated, analyzed, and used to suggest individual enrollment item(s) or an academic program of enrollment items that match individual student interest(s) or a set of student interests. The recommendation service may also monitor student actions that are taken based on or in light of the suggestion, and the recommendation service may adjust future suggestions based on these actions.

The recommendation service may be exposed, to students or applications, via an interface hosted by the recommendation servers. For example, the recommendation service may be exposed as an application programming interface, a Web service interface, a graphical user interface, or any other interface that receives or otherwise accepts input about student interests, automatically determines a recommendation comprising suggested enrollment items based at least in part on the student interests, and displays or otherwise provides output of the recommendation. In one example, a prospective student may use an Enrollment User Interface to search and find the program that best meets the prospective student's goals. In another example, a student already enrolled at an institution uses the Enrollment User Interface to customize the program that the student is pursuing at the institution. If the institution already provides a high level course catalog for the program, the interface can be used to customize optional courses or electives in the program based on factors known to the recommendation service such as job market trends, what courses others in the student's social circle have opted for, and/or latest expert research on the subject and competing institutions. In these examples, the recommendation service selects one or more enrollment items that are predicted to meet student career goal(s), educational goal(s), or other interest(s) of the student.

By receiving input, providing suggestions, and monitoring student activity, the recommendation service may learn about a particular student, groups of students, and/or students in general. For example, the individual, group, or body of students may have expressed certain interests in the past, and the recommendation service can learn, based on these past interests, future interests of the individual, group, or body of students. In one embodiment, certain interests are correlated with each other, and a student may be predicted to have an unknown interest based on other known interests of the student.

Similarly, the recommendation service may learn about individual enrollment items, programs of enrollment items, and/or enrollment items in general. For example, the individual, program, or entire curriculum of enrollment items at an educational institution may, based on past measurements, have certain characteristics, and the recommendation service can learn, based on these characteristics, future characteristics of the individual, program, or entire curriculum. In one embodiment, certain characteristics are correlated with each other, and an enrollment item may be predicted to have an unknown characteristic based on other known characteristics of the enrollment item.

By learning about the students and the enrollment items, thereby predicting unknown characteristics about the students and the enrollment items, the recommendation service may continue to improve its recommendations by matching the students and enrollment items based on known and unknown characteristics. The recommendations may be further evaluated and improved based on whether or not users adopt the recommendations or elect to adopt alternatives.

In one embodiment, the recommendation service receives a request for an enrollment recommendation. The recommendation service may operate on a server that is internal or external to an academic institution, which may have other servers operating to provide academic services from an internal network. The request may include or reference one or more interest parameters, which may include one or more interest parameters that are specified by a user that originated the request. For example, the interface may provide options for the user to specify example queries, in free-form or from a pre-defined set of options:
What skills can get me job faster or get me a higher paying job?
Which options are associated with higher paying jobs?
What is the popular course?
What is the popular program?
What is the best certification program in terms of salary or job placement?
I have X amount to spend on learning what is the best course/program to get me a job?
What are my most cost-effective options?
What is the quickest outcome I can achieve?
What courses should I take to get a particular certification?
What courses should I take to get a particular degree?
What options have the most financial aid available?
What options maximize a likelihood of job placement?
What options allow me to obtain particular skills?
What options provide the best likelihood of obtaining a particular position or a position at a particular company?
What options are most aligned with a particular other academic institution?
What are the most popular or trending options?
   The enrollment service may be specially configured to provide a recommendation based on any one or more of these queries. The enrollment service may automatically determine a recommendation and, in response to the request, cause display of the recommendation comprising information about a particular enrollment item.

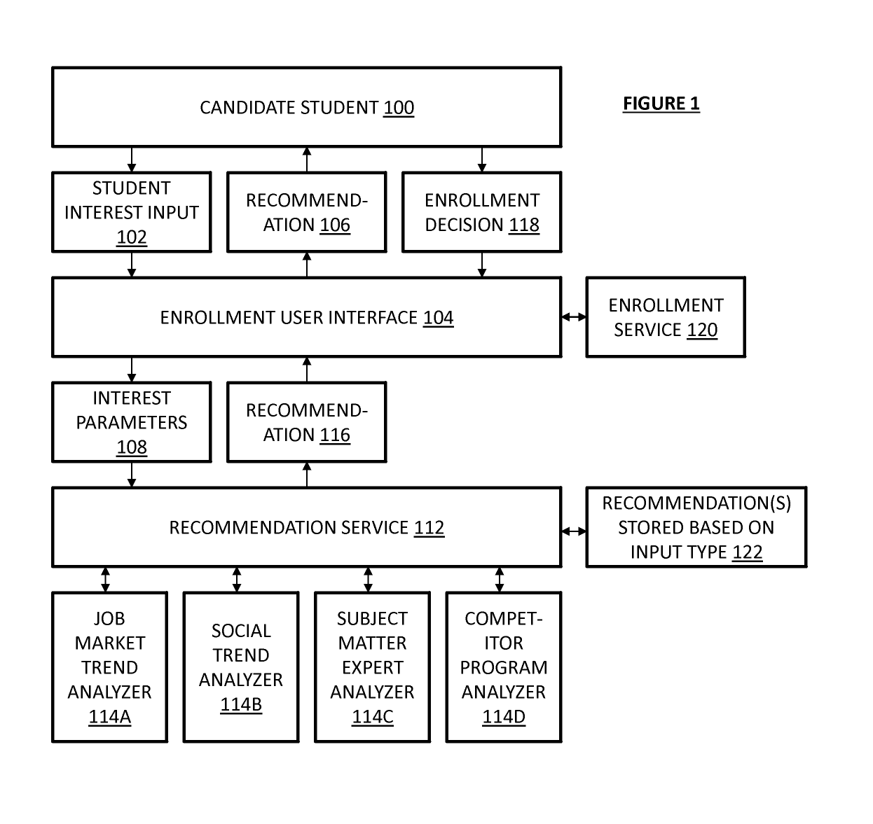

FIG. 1 illustrates an example system for suggesting enrollment items to candidate students. As shown, a candidate student 100, such as a current student or a prospective student, communicates student interest input 102 to enrollment user interface 104. Enrollment user interface 104 may determine interest parameters 108 from the student interest input 102 and/or from information that was stored, before receiving student interest input 102, about candidate student 100.

Enrollment user interface 104 sends interest parameters 108 to a recommendation service 112. The recommendation service 112 may use any, some, or all of analyzers 114 to match interest parameters 108 to enrollment item characteristics. The analyzer(s) used by the recommendation service 112 in any given situation may be selected based at least in part on the student interest input 102. For example, in response to student interest input that specifies an interest in job market trends, enrollment user interface 104 may cause recommendation service 112 to use job market trend analyzer 114A. Job market trend analyzer 114A determines job market trend characteristics of enrollment items. For example, students who took one course may be more likely to be employed a year after graduation than students who took another course.

Also as shown, recommendation service 112 may use social trend analyzer 114B to determine social trend characteristics of enrollment items. For example, more friends of candidate student 100 may be taking one course instead of another course. As another example, friends who took the course may have been more successful, in terms of employment rate or salary, than friends who did not take the course.

In addition to or instead of other analyzers, recommendation service 112 may use subject matter expert analyzer 114C to determine trends, among the enrollment items, of subject matter expert ratings, suggestions, or opinions. For example, a first counselor may recommend a first course for computer science students, and a second counselor may recommend a second course instead of the first course for computer science students. The ratings or recommendations of multiple counselors may be weighed to determine an aggregate rating.

As shown in FIG. 1, recommendation service 112 may weigh ratings from multiple analyzers 114s to provide an aggregate recommendation 116 for candidate student 100. The recommendation 116 is sent to enrollment user interface 104, which causes display of recommendation 106 to candidate student 100. Upon receiving recommendation 106, candidate student 100 may select an enrollment option on enrollment user interface 104, thereby communicating an enrollment decision 118 to enrollment user interface 104. Upon receiving enrollment decision 118, enrollment user interface 104 may cause selected enrollment item(s) to be reserved by enrollment service 120. Enrollment service 120 may keep track of which students are registered for which courses and how much room is left in certain courses.

Recommendation service 112 may retain any recommendations that have already been provided as recommendations in storage based on input type 122. Upon receiving similar input in the future, the stored recommendations 122 may be used by recommendation service 112 instead of re-determining recommendations from the collected data.

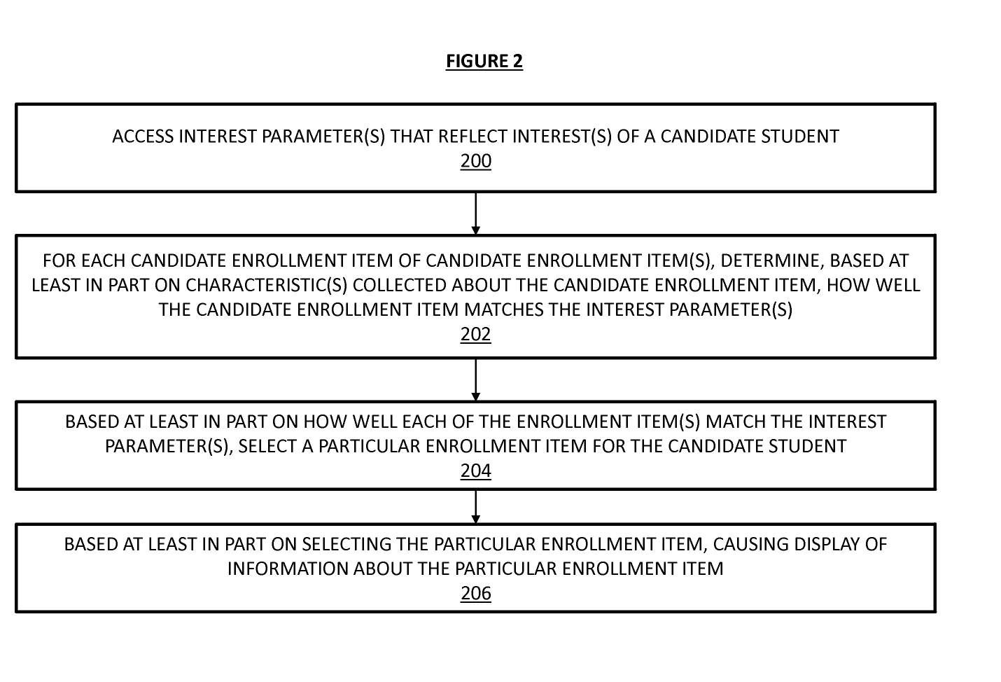

FIG. 2 illustrates an example process for suggesting enrollment items to candidate students. In step 200, a recommendation service accesses interest parameter(s) that reflect interest(s) of a candidate student. For each candidate enrollment item of candidate enrollment item(s), the recommendation service determines, in step 202 based at least in part on characteristic(s) collected about the candidate enrollment item, how well the candidate enrollment item matches the interest parameter(s). Then, in step 204, the enrollment server selects a particular enrollment item for the candidate student based at least in part on how well each of the enrollment item(s) match the interest parameter(s). In step 206, based at least in part on selecting the particular enrollment item, the enrollment service causes display of information about the particular enrollment item.

### Interest Parameters

In one embodiment, the recommendation service accesses one or more interest parameters that reflect one or more interests of a candidate student. The user interface may receive interest parameters from the candidate student via text input regions, by the selection of graphical objects such as buttons or checkboxes, by associating the student with stored information, or by any other technique for learning information about a user via an interface. The interest parameters may specify goals, specializations, questions, or other inquiries of the student.

For example, profile information of the student may be retrieved from a student profile server, which may be maintained on a same internal network or even a same machine as the recommendation server. Alternatively, the profile information may be retrieved from a social networking service that maintains profiles for students and other users. The student may be associated with a profile once the student is authenticated as a subject of the profile. The recommendation server may associate the student with one or more social network profiles in response to a user-selection of an option to connect the social network profiles to a student profile. In one example, the stored information is automatically retrieved for the student based on authentication information that is retained by a browser as a cookie. In another example, the recommendation server may prompt the student for authentication information that is required to retrieve the stored information from the social networking service. In yet another example, the recommendation server may automatically retrieve public information about the student from one or more social networking profiles, such as public or partially public profiles, or Web sites associated with the student.

The information about the student may be defined as or otherwise correlated with certain interest parameters that describe interests of the student. For example, a student's major field of study, as determined from a student profile, may describe a general educational interest of the student in a long-term educational program, and the student's inquiry about computer programming courses may describe a specific educational interest of the student in a course or set of courses. In one example, information about a student may be gleaned from a student's profile, and the profile may be stored internally to an academic institution.

In various embodiments the one or more interest parameters include one, two, or more of: a budget-related goal or target budget, a certificate-related goal or target certificate, a degree-related goal or target degree, a time-related goal or target amount of time spent, a difficulty-related goal or target difficulty, a salary-related goal or target salary, a financial aid related goal or target amount of financial aid, a job placement goal or target likelihood of job placement, a skill-related goal or target skill, an employment position related goal or target employment position, a goal to take courses with friends or target friends with whom to take courses, a goal to take expert advice or target experts from whom to take advice, a geography-related goal or a target geographic region, and/or an enrollment institution related goal or a target enrollment institution.

### Determining Characteristics of Enrollment Items

The enrollment server may collect information about the enrollment items from one or multiple sources and determine or estimate characteristics of the enrollment items based on the collected information. For example, a course at an educational institution may have characteristics that are based on various types of information, including, for example: a description of a course or similar courses, expert ratings of the course or similar courses, information about professionals who took the course or similar courses, information about a student's friends who are taking the course or similar courses, and/or information about similar courses that are or are not offered at other educational institutions.

In one embodiment, at least one of the characteristics collected about the particular enrollment item accounts for two or more different sources of a same type. In other words, multiple sources may contribute to a characteristic that is based on a single type of information. For example, the recommendation service may collect different opinions from different experts about the course or similar courses, and these different opinions may be used to determine and/or improve the recommendation.

In a particular example, at least a first source and a second source of the different sources provide at least partially conflicting information about the particular enrollment item. First information from at least the first source is weighed against second information from at least the second source to determine a weighted score for the particular enrollment item. For example, a first expert may provide a high job placement rating of 8/10 for a course, and a second expert may provide a low job placement rating of 4/10 for a course. The ratings may be combined to form a weighted score of 6/10 for the course.

In various embodiments, at least one of the characteristics collected about the particular enrollment item accounts for any combination of two or more of: job listings, employment data, contacts in a social network, subject-matter expert recommendations, enrollment offerings by independent enrollment institutions, explicit feedback regarding past enrollment items, and/or implicit feedback regarding past enrollment items.

In one embodiment, the enrollment server collects and maintains information for individual enrollment items, sets of enrollment items, and/or characteristics that are unique among enrollment items or shared by multiple enrollment items. For example, the enrollment server may keep track of information about different learning activities for different courses. A learning activity can be an e-book, video, audio, quiz, or assignment, such as Discrete Fourier Transform (DFT) and Fast Fourier Transform (FFT) (Chapters 8 and 9). A course may cover multiple learning activities, and courses may overlap in learning activities. The learning activities may be determined from the course description, which may be in a course catalogue, a course syllabus, or a document internal to the institution to evaluate academic programs or courses. Courses at the same or competing institutions may cover same or similar learning activities, and these courses may be predicted to be equivalents or similar based on these same or similar learning activities.

In another example, the enrollment server may keep track of information about different objectives for different courses. The objectives may specify skills or qualifications that a student should have after completing an academic activity. An academic activity such as a program, certification program, course, or learning activity may fulfill one or more of the objectives when the academic activity is completed or as the student makes progress on the activity. The objectives may be stored in an objective store or other repository and linked to various objects such as a Program object, a Course object, and/or a Learning Activity object.

The enrollment server may also keep track of different outcomes for different students who took same or different courses. An outcome specifies skills or qualifications that the student actually achieved from an academic activity. For example, after two students take a course on computer architecture, one of the students may have mastered the concept of pipelined processing, while another of the students may not have mastered that concept by completion of the course. Different outcomes may be achieved by students selecting different learning activities within a course, by students performing at different levels for different learning activities, or by students taking same courses from different professors or at different institutions.

### Matching Candidate Enrollment Items to Student Interests

The recommendation service may determine, for each candidate enrollment item of multiple candidate enrollment items, based at least in part on one or more characteristics collected about the candidate enrollment item, how well the candidate enrollment item matches the one or more interest parameters that reflect one or more interests of a candidate student.

For at least a particular enrollment item of the multiple candidate enrollment items, at least one of the characteristics collected about the particular enrollment item may account for information from different sources.

In one embodiment, the recommendation service assigns a score to each enrollment item or rank order among enrollment items based on how well the item matches one or more interest parameters that reflect one or more interests of a candidate student. Based at least in part on how well each of the two or more candidate enrollment items match the one or more interest parameters, the recommendation service selects the particular enrollment item or a set of enrollment items for the candidate student.

For example, a candidate student may specify an interest in one, two, or more of having friends in his or her class, maximizing pay, maximizing a likelihood of job placement, obtaining a certain degree, or other interests. The recommendation service matches characteristics of the specified interests with characteristics of candidate enrollment items to determine a best fitting enrollment item for the candidate student.

The recommendation service may learn about student interests by clustering the student interests into interest profiles. For example, one cluster may be assigned to computer science students interested in finance. The recommendation service may learn, based on collected or otherwise received data, interests such as career goals, groups of friends, salary goals, and/or desired courses or outcomes that collectively define computer science students interested in finance. The learning may be performed based on training data about past student interests, past student choices, and/or effects of those choices on past students, and the training data may be clustered to predict unknown data. Once a candidate student has been associated with the cluster, the recommendation service may predict that the candidate student shares other interests of other students in the cluster. The recommendation service may also learn over time based on accurate and/or inaccurate predictions regarding student interests.

The recommendation service may also learn about enrollment item characteristics by clustering the enrollment item characteristics into enrollment item profiles. For example, one cluster may be assigned to courses that have learning activities, objectives, and/or outcomes collectively defined as introductory calculus. The learning may be performed based on training data about past course characteristics, past student choices, and/or effects of those choices on past students, and the training data may be clustered to predict unknown data. Once an enrollment item has been associated with the cluster, the recommendation service may suggest the enrollment item instead of or in addition to other introductory calculus courses or other calculus courses. The recommendation service may suggest the item to candidate students who are interested in objectives, groups of friends, or other characteristics associated with introductory calculus. The recommendation service may also learn over time based on accurate and/or inaccurate predictions regarding course characteristics.

### Analyzing Job Market Trends

In one embodiment, a job market trend analyzer is part of or in communication with the recommendation server. The job market trend analyzer is configured to access feeds from various professional network services and job sites such as Dice™, Monster™, CareerBuilder™ Ladders™, Glassdoor™, LinkedIn™, etc. The job market trend analyzer may also crawl company job sites to determine, from recent job postings, job requirement information such as required degrees or skills, job role information such as management or product development, and job benefit information such as expected salary. The objective store may be internal to the recommendation server. The collected job information may be indexed and stored on local storage of the job market trend analyzer for faster look up.

In one example, the information specified in a job listing may be mapped to objectives stored in an objective store. With this mapping between externally desirable skill sets from the job listings and internally possible skill sets in the objective store, the recommendation server may determine which enrollment item or set of enrollment items can be used to attain the skills that are necessary to get certain jobs or certain types of jobs. Accordingly, the recommendation server may use the job trend information to suggest a best match for a student interested in job placement or salary.

In one example, the candidate student specifies, via the interface, an interest in a particular company. The recommendation service analyzes job listing data associated with the particular company, and prepares a recommendation for the student to maximize the student's possibility of job placement at the particular company. For example, the recommendation service may determine which skills and degrees are frequently required by the particular company, and the recommendation service may steer the candidate student in a direction that is likely to be required by the particular company when the candidate student enters the workforce.

### Analyzing Social Trends

In one embodiment, a social trend analyzer is part of or in communication with the recommendation server. The social trend analyzer is configured to access feeds or conversations related to careers, skills, programs, degrees or certifications, courses, professors, or other characteristics of enrollment items. Such information may be captured from social networking sites such as Facebook™, Twitter™, LinkedIn™, or Google+™.

The social trend analyzer may keep track of which enrollment items or characteristics of enrollment items are popular in a candidate student's social circle, and the enrollment service may provide a recommendation based on the popularity of an enrollment item or the popularity of characteristics of the enrollment item. For example, enrollment items that are more popular among a student's friends and/or friends of friends may be suggested to the student for enrollment, and items that are less popular may not be suggested for enrollment.

The social trend analyzer may also be used to suggest enrollment items based on other students, as determined from social networking data or data from professional networking sites, who have been successful in the candidate student's field. For example, a recommendation for a candidate student in economics may be generated based on other economics students who recently graduated and got well-paying jobs. Such information may be available from social or professional networking sites and/or retrieved from questionnaires that are internal to an academic institution.

### Analyzing Opinions of Subject Matter Experts

In one embodiment, a subject matter expert (SME) analyzer is part of or in communication with the recommendation server. The SME analyzer is configured to access feeds from research institutes or experts. The SME analyzer may analyze feedback from SMEs related to enrollment items or characteristics of the enrollment items. The SME analyzer may crawl the web and gather relevant information about courses or fields of study. The SME analyzer may also gather information internally from experts of an academic institution.

The SME opinions may be weighted based on the similarity of the SME and the candidate student. For example, SMEs in a similar geographic region as the candidate student may be given a higher weight than SMEs in a different geographic region. As another example, SMEs at an academic institution of the candidate student or teaching in a field of expertise that is similar to the field of the candidate student may be given a higher weight than SMEs at different institutions or in different fields.

The SME opinions may also be weighted based on student feedback about the usefulness of the SME opinions. For example, opinions from experts who are frequently rated, by students, as helpful may receive higher weights than opinions from experts who are frequently rated, by students, as unhelpful.

### Analyzing Competitor Programs

In one embodiment, a competitor program analyzer is part of or in communication with the recommendation server. The competitor program analyzer is configured to crawl public or shared information from other academic institutions to get information about programs, courses, and/or learning activities that are offered at the other academic institutions. This information may be presented to a candidate student concurrently with an enrollment recommendation, and/or the information may be used to recommend enrollment items.

### Providing Recommendations

Based at least in part on selecting the particular enrollment item, the recommendation service causes display of a recommendation comprising information about the particular enrollment item. When providing the recommendation, which may include information about one or multiple enrollment items, the recommendation service may filter out some enrollment items and keep other enrollment items. The recommendation service may provide a single recommendation or multiple alternative, complimentary, or supplementary recommendations, and each of the multiple recommendations may be scored or rank ordered based on how well it matches interests of the student.

For example, the recommendation service may provide a recommendation selection interface that presents options to select from multiple recommendations of sets of courses that match the student's interests.

In one embodiment, the recommendation service causes display of information about the particular enrollment item that may include, for example, a degree of confidence or score in the particular enrollment item. The degree of confidence or score quantifies how well the particular enrollment item matches the one or more interest parameters of the candidate student.

The recommendation service may also provide, via the interface, an option for the candidate student to view additional information about how the degrees of confidence were determined. For example, the recommendation service may cause display of information about a first evaluation of the particular enrollment item by a first source of different sources and information about a second evaluation of the particular enrollment item by a second source of the different sources. The different evaluations may contribute to a weighted score having a certain degree of confidence. The recommendation service may further provide, via the interface, options to ignore certain sources or increase or reduce the weights of certain sources. If the recommendation service receives user input to ignore sources or change the weights, the recommendation service may determine a new recommendation that accounts for the changes.

In one embodiment, the recommendation service provides, via the interface, information about the differences between different options. For example, the recommendation service may cause display, on the interface, of information about a difference in salary that is expected if one course is taken instead of another course. In a particular example, a candidate student may expect to receive a 5% greater salary if the candidate student takes a Discrete Math course instead of a Logic and Reasoning course.

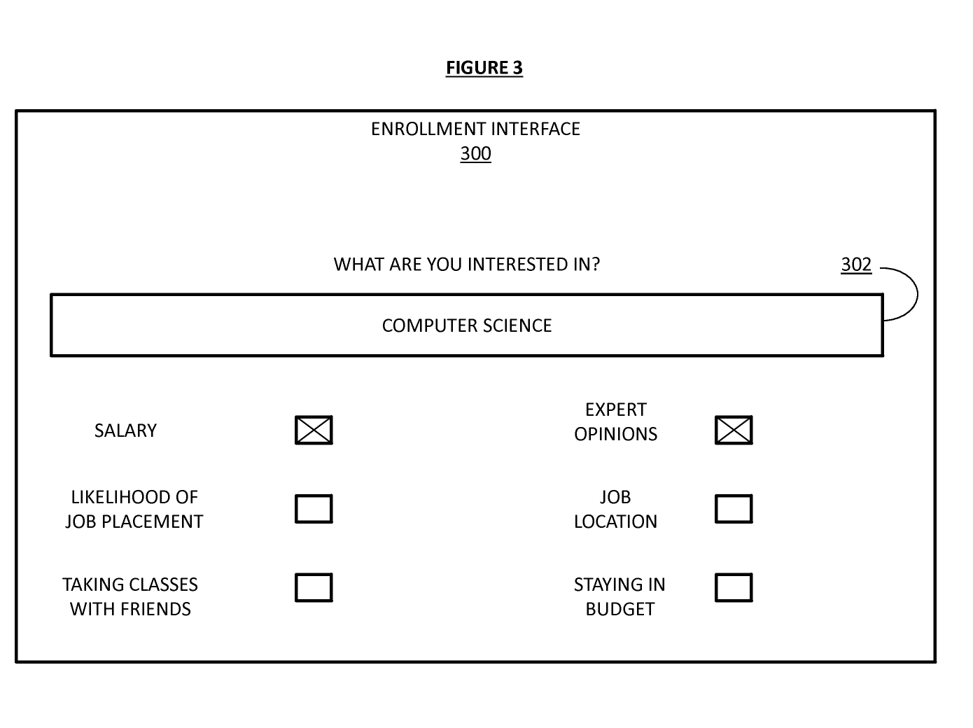

FIG. 3 illustrates an example enrollment interface that prompts a candidate student for interest input. As shown, enrollment interface 300 provides several options for expressing student interests. Free form input box 302 accepts text input, and parses the text to determine what topics are being requested by the candidate student. As shown, a candidate student has expressed an interest in computer science courses. Enrollment interface 300 may also provide options for selecting from among pre-defined interests, such as salary, likelihood of job placement, taking classes with friends, expert opinions, job location, and/or staying in budget. As shown, a candidate student may have selected, via checkboxes on enrollment interface 300, courses that are well-rated for salary potential and well rated according to expert opinions.

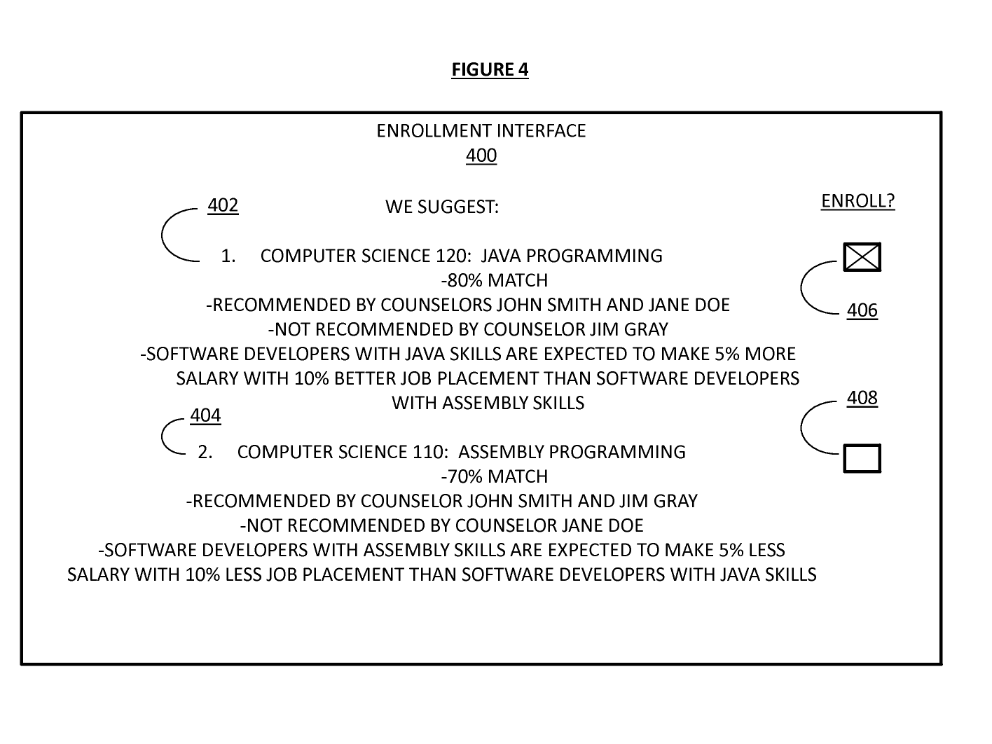

FIG. 4 illustrates an example enrollment interface that displays enrollment options and details about suggested enrollment items. After receiving inputs from free form input box 302 and other selected interests, enrollment interface 400 may suggest enrollment items 402 and 404. Enrollment interface 400 may cause display of information, as shown, such as the name or description of the course, how well the course matches the student interest(s), what source(s) contributed to determining that the course matches the student interest(s), and outcomes that can be expected by taking the course. Enrollment interface 400 may also cause display of other information, such as how many friends are taking the course, what days and times the course is offered, who is teaching the course, and what companies are seeking jobs with skills that would be attained by taking the course.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

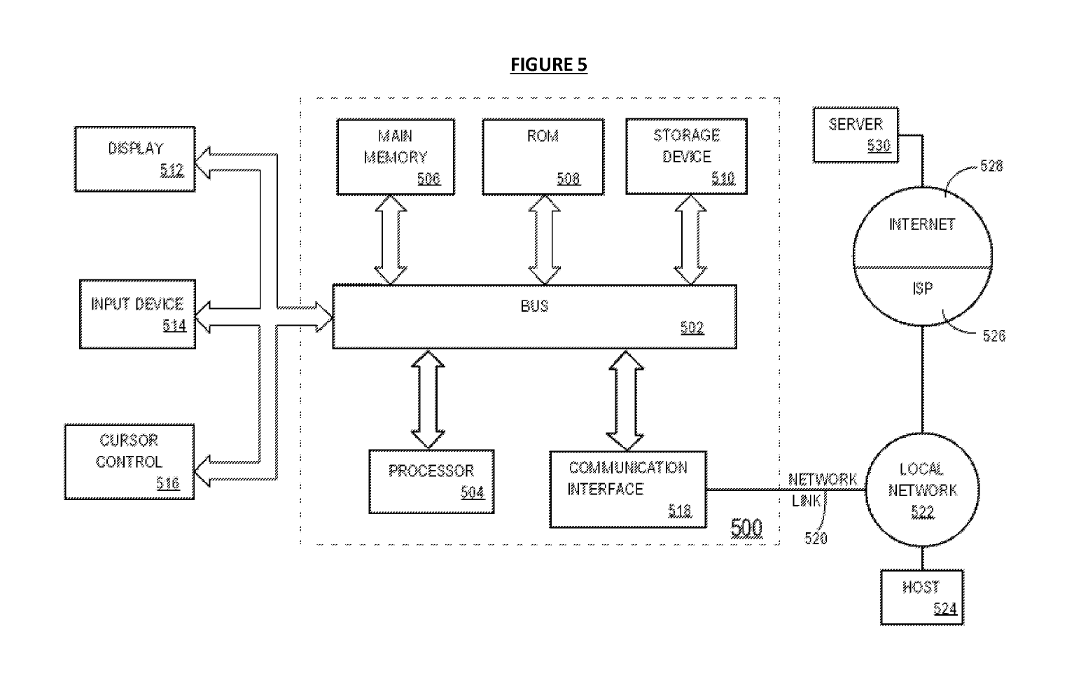

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a light emitting diode (LED) display, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
accessing one or more interest parameters that reflect one or more interests of a candidate student;
for each candidate enrollment item of two or more candidate enrollment items, determining, based at least in part on one or more characteristics collected about the candidate enrollment item, how well the candidate enrollment item matches the one or more interest parameters;
wherein, for at least a particular enrollment item of the two or more candidate enrollment items, at least one of the characteristics collected about the particular enrollment item accounts for information from at least two different sources;
based at least in part on how well each of the two or more candidate enrollment items match the one or more interest parameters, selecting the particular enrollment item for the candidate student;
based at least in part on selecting the particular enrollment item, causing display of information about the particular enrollment item;
wherein the method is performed by one or more computing devices.

2. The method of claim 1, wherein at least one of the characteristics collected about the particular enrollment item accounts for one of: job listings, employment data, contacts in a social network, subject-matter expert recommendations, enrollment offerings by independent enrollment institutions, explicit feedback regarding past enrollment items, or implicit feedback regarding past enrollment items.

3. The method of claim 1, wherein at least one of the characteristics collected about the particular enrollment item accounts for two or more of: job listings, employment data, contacts in a social network, subject-matter expert recommendations, enrollment offerings by independent enrollment institutions, explicit feedback regarding past enrollment items, or implicit feedback regarding past enrollment items.

4. The method of claim 1, wherein at least one of the characteristics collected about the particular enrollment item accounts for two or more different sources of a same type.

5. The method of claim 4, wherein at least a first source and a second source of the two or more different sources provide at least partially conflicting information about the particular enrollment item, and wherein first information from at least the first source is weighed against second information from at least the second source.

6. The method of claim 1, wherein the one or more interest parameters include one of: a budget-related goal or target budget, a certificate-related goal or target certificate, a degree-related goal or target degree, a time-related goal or target amount of time spent, a difficulty-related goal or target difficulty, a salary-related goal or target salary, a financial aid related goal or target amount of financial aid, a job placement goal or target likelihood of job placement, a skill-related goal or target skill, an employment position related goal or target employment position, a goal to take courses with friends or target friends with whom to take courses, a goal to take expert advice or target experts from whom to take advice, a geography-related goal or a target geographic region, or an enrollment institution related goal or a target enrollment institution.

7. The method of claim 1, wherein the one or more interest parameters include two or more of: a budget-related goal or target budget, a certificate-related goal or target certificate, a degree-related goal or target degree, a time-related goal or target amount of time spent, a difficulty-related goal or target difficulty, a salary-related goal or target salary, a financial aid related goal or target amount of financial aid, a job placement goal or target likelihood of job placement, a skill-related goal or target skill, an employment position related goal or target employment position, a goal to take courses with friends or target friends with whom to take courses, a goal to take expert advice or target experts from whom to take advice, a geography-related goal or a target geographic region, or an enrollment institution related goal or a target enrollment institution.

8. The method of claim 1, wherein causing display of the information about the particular enrollment item includes causing display of a degree of confidence in the particular enrollment item, wherein the degree of confidence quantifies how well the particular enrollment item matches the one or more interest parameters.

9. The method of claim 1, further comprising receiving a request for an enrollment recommendation, wherein the request comprises at least one of the one or more interest parameters, wherein the at least one of the one or more interest parameters is user-specified by a user that originated the request, and wherein the display of the information about the particular enrollment item is caused in response to the request.

10. The method of claim 1, further comprising causing display of information about a first evaluation of the particular enrollment item by a first source of the at least two different sources and information about a second evaluation of the particular enrollment item by a second source of the at least two different sources.

11. One or more non-transitory computer-readable storage media storing instructions which, when executed, cause:
accessing one or more interest parameters that reflect one or more interests of a candidate student;
for each candidate enrollment item of two or more candidate enrollment items, determining, based at least in part on one or more characteristics collected about the candidate enrollment item, how well the candidate enrollment item matches the one or more interest parameters;
wherein, for at least a particular enrollment item of the two or more candidate enrollment items, at least one of the characteristics collected about the particular enrollment item accounts for information from at least two different sources;
based at least in part on how well each of the two or more candidate enrollment items match the one or more interest parameters, selecting the particular enrollment item for the candidate student; and
based at least in part on selecting the particular enrollment item, causing display of information about the particular enrollment item.

12. The one or more non-transitory computer-readable storage media of claim 11, wherein at least one of the characteristics collected about the particular enrollment item accounts for one of: job listings, employment data, contacts in a social network, subject-matter expert recommendations, enrollment offerings by independent enrollment institutions, explicit feedback regarding past enrollment items, or implicit feedback regarding past enrollment items.

13. The one or more non-transitory computer-readable storage media of claim 11, wherein at least one of the characteristics collected about the particular enrollment item accounts for two or more of: job listings, employment data, contacts in a social network, subject-matter expert recommendations, enrollment offerings by independent enrollment institutions, explicit feedback regarding past enrollment items, or implicit feedback regarding past enrollment items.

14. The one or more non-transitory computer-readable storage media of claim 11, wherein at least one of the characteristics collected about the particular enrollment item accounts for two or more different sources of a same type.

15. The one or more non-transitory computer-readable storage media of claim 14, wherein at least a first source and a second source of the two or more different sources provide at least partially conflicting information about the particular enrollment item, and wherein first information from at least the first source is weighed against second information from at least the second source.

16. The one or more non-transitory computer-readable storage media of claim 11, wherein the one or more interest parameters include one of: a budget-related goal or target budget, a certificate-related goal or target certificate, a degree-related goal or target degree, a time-related goal or target amount of time spent, a difficulty-related goal or target difficulty, a salary-related goal or target salary, a financial aid related goal or target amount of financial aid, a job placement goal or target likelihood of job placement, a skill-related goal or target skill, an employment position related goal or target employment position, a goal to take courses with friends or target friends with whom to take courses, a goal to take expert advice or target experts from whom to take advice, a geography-related goal or a target geographic region, or an enrollment institution related goal or a target enrollment institution.

17. The one or more non-transitory computer-readable storage media of claim 11, wherein the one or more interest parameters include two or more of: a budget-related goal or target budget, a certificate-related goal or target certificate, a degree-related goal or target degree, a time-related goal or target amount of time spent, a difficulty-related goal or target difficulty, a salary-related goal or target salary, a financial aid related goal or target amount of financial aid, a job placement goal or target likelihood of job placement, a skill-related goal or target skill, an employment position related goal or target employment position, a goal to take courses with friends or target friends with whom to take courses, a goal to take expert advice or target experts from whom to take advice, a geography-related goal or a target geographic region, or an enrollment institution related goal or a target enrollment institution.

18. The one or more non-transitory computer-readable storage media of claim 11, wherein causing display of the information about the particular enrollment item includes causing display of a degree of confidence in the particular enrollment item, wherein the degree of confidence quantifies how well the particular enrollment item matches the one or more interest parameters.

19. The one or more non-transitory computer-readable storage media of claim 11, further comprising instructions for receiving a request for an enrollment recommendation, wherein the request comprises at least one of the one or more interest parameters, wherein the at least one of the one or more interest parameters is user-specified by a user that originated the request, and wherein the display of the information about the particular enrollment item is caused in response to the request.

20. The one or more non-transitory computer-readable storage media of claim 11, further comprising instructions for causing display of information about a first evaluation of the particular enrollment item by a first source of the at least two different sources and information about a second evaluation of the particular enrollment item by a second source of the at least two different sources.
